(19) United States
(12) Patent Application Publication
(10) Pub. No.: US 2010/0107804 A1
(43) Pub. Date: May 6, 2010

(54) FIXED PEDAL ASSEMBLY WITH MULTI-PIECE SUPPORT BRACKET AND CAPTIVE PIVOT

(76) Inventors: Stuart A. Tervol, Rochester Hills, MI (US); Steven J. Colarossi, Chesterfield, MI (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/264,673

(22) Filed: Nov. 4, 2008

(51) Int. Cl. G05G 1/44

(52) U.S. Cl. 74/512

(57) ABSTRACT

A pedal assembly includes a mounting bracket and a pedal arm having a lower end carrying a pedal and an upper end having a pivot forming a laterally disposed pivot axis. The mounting bracket includes first and second lateral components which are formed as separate components and secured together to laterally capture the pivot therebetween such that the first and second components support the pivot and the pedal arm is pivotable about the pivot axis relative to the mounting bracket. The first and second components are each preferably molded of plastic and each form a laterally inward facing socket for receiving opposed ends of the pivot therein. The laterally outward end of each socket is at least partially closed and a spring member is located in one the sockets to resist lateral movement of the pedal arm relative to the mounting bracket.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The field of the present invention generally relates to control pedals and, more particularly, to control pedals for motor vehicles.

### BACKGROUND OF THE INVENTION

Control pedals are typically provided in a motor vehicle, such as an automobile, which are foot operated by the driver. Separate control pedals are provided for operating brakes and an engine throttle. When the motor vehicle has a manual transmission, a third control pedal is provided for operating a transmission clutch.

Control pedal assemblies typically include a mounting bracket and a pedal arm pivotably attached to the mounting bracket. The pedal arm typically has a foot plate or pedal pad at a lower end and a bushing holder or hub at an upper end. A pivot pin is placed through the hub and the mounting bracket so that the pedal arm is pivotable relative to the mounting bracket when an operator presses the foot plate. The pivot pin must be spun or provided with a retainer to secure the pivot pin in position. The pedal arm is also provided with a suitable output connector so that the movement of the pedal operates the device to be controlled, such as a brake master cylinder, engine throttle or transmission clutch, in a desired manner.

While these prior art pedal assemblies may operate adequately operate, there is a never ending desire in the motor vehicle industry to reduce cost while maintaining or improving reliability. Accordingly, there is a need in the art for an improved pedal assembly which is relatively simple and inexpensive to produce and is highly reliable to operate.

### SUMMARY OF THE INVENTION

The present invention provides a pedal assembly which overcomes at least some of the above-noted problems of the related art. According a disclosed embodiment of the present invention, a pedal assembly comprises, in combination, a mounting bracket and a pedal arm having a lower end carrying a pedal and an upper end having a pivot forming a laterally disposed pivot axis. The mounting bracket includes first and second lateral components formed as separate components and secured together to laterally capture the pivot therebetween such that the first and second components support the pivot and the pedal arm is pivotable about the pivot axis relative to the mounting bracket.

According to another disclosed embodiment of the present invention, a pedal assembly comprises, in combination, a fixed position mounting bracket and a pedal arm having a lower end carrying a pedal and an upper end having a pivot forming a laterally disposed pivot axis. The mounting bracket includes first and second lateral components which are formed as separate components and secured together to laterally capture the pivot therebetween such that the first and second components support the pivot and the pedal arm is pivotable about the pivot axis relative to the mounting bracket. The first and second components each form a laterally inward facing socket for receiving opposed ends of the pivot therein.

According to yet another disclosed embodiment of the present invention, a pedal assembly comprises, in combination, a mounting bracket and a pedal arm having a lower end carrying a pedal and an upper end having a pivot forming a laterally disposed pivot axis. The mounting bracket includes first and second lateral components which are formed as separate components and secured together to laterally capture the pivot therebetween such that the first and second components support the pivot and the pedal arm is pivotable about the pivot axis relative to the mounting bracket. The first and second components are each preferably molded of plastic and each form a laterally inward facing socket for receiving opposed ends of the pivot therein. The laterally outward end of each socket is at least partially closed and a spring member is located in one the sockets to resist lateral movement of the pedal arm relative to the mounting bracket.

From the foregoing disclosure and the following more detailed description of various preferred embodiments it will be apparent to those skilled in the art that the present invention provides a significant advance in the technology and art of control pedal assemblies. Particularly significant in this regard is the potential the invention affords for providing a reliable and low cost assembly. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a control pedal assembly according to the present invention;

FIG. 2 is an exploded perspective view of the control pedal assembly of FIG. 1;

FIG. 3 is a left side elevational view of the control pedal assembly of FIGS. 1 and 2;

FIG. 4 is a rear elevational view of the control pedal assembly of FIGS. 1 to 3;

FIG. 5 is a right-side elevational view of the control pedal assembly of FIGS. 1 to 4;

FIG. 6 is a cross-sectional view taken along line 6-6 of FIG. 3 showing a spring biased pivot;

FIG. 7 is a cross-sectional view taken along line 7-7 of FIG. 3 showing a heat staked connection; and

FIG. 8 is a cross sectional view taken along line 8-8 of FIG. 4 showing mounting holes with crush-limiters.

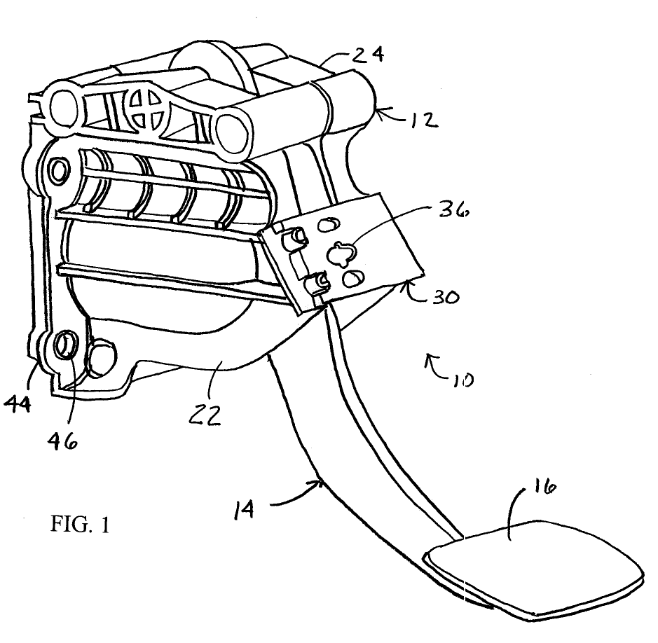

It should be understood that the appended drawings are not necessarily to scale, presenting a somewhat simplified representation of various preferred features illustrative of the basic principles of the invention. The specific design features of control pedal assemblies as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the adjustable control pedal assemblies illustrated in the drawings. In general, up or upward refers to an upward direction within the plane of the paper in FIG. 1 and down or downward refers to a downward direction within the plane of the paper in FIG. 1. Also in general, fore or forward refers to a direction toward the front of the motor vehicle and aft or rearward refers to a direction toward the rear of the motor vehicle.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved control pedal assemblies disclosed herein. The following detailed discussion of various alternative and preferred embodiments will illustrate the general principles of the invention with reference to a brake pedal for use with a motor vehicle. Other embodiments suitable for other applications will be apparent to those skilled in the art given the benefit of this disclosure. While the illustrated pedal assembly is adapted as a brake pedal, it is noted that pedal assembly can alternatively be adapted as an accelerator, clutch, or other desired foot pedal within the scope of the present invention. Also, while the illustrated embodiments of the present invention are particularly adapted for use with an automobile, it is noted that the present invention can be utilized with any vehicle having at least one foot operated control pedal including trucks, buses, vans, recreational vehicles, earth moving equipment and the like, off road vehicles such as dune buggies and the like, air borne vehicles, and water borne vehicles.

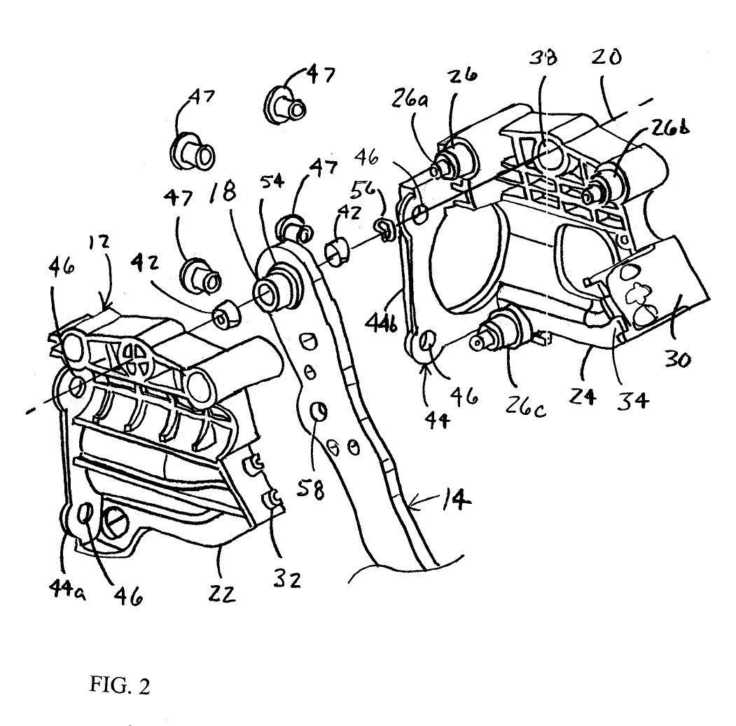

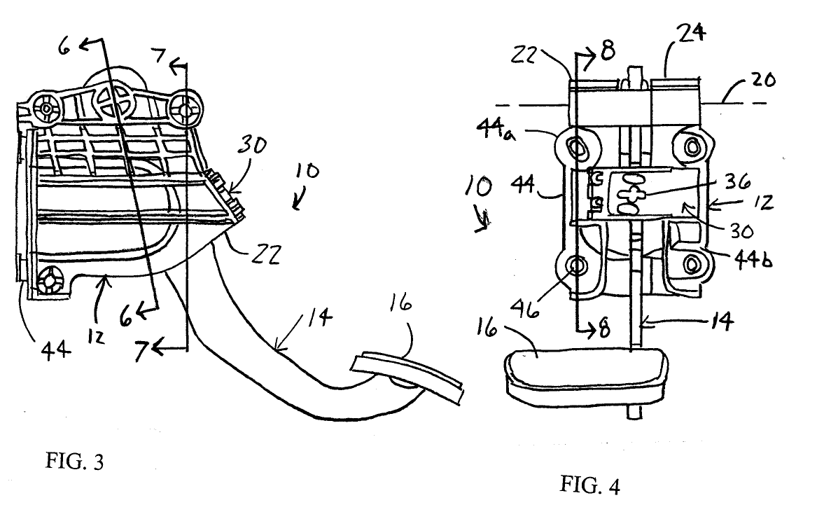

Referring now to the drawings, FIGS. 1 to 5 show a control pedal assembly 10 according to a preferred embodiment of the present invention. The illustrated control pedal assembly 10 includes a fixed position support or mounting bracket 12 and a pedal arm 14 having a lower end carrying a pad or pedal 16 for engagement by the foot of the motor vehicle operator and an upper end having a pivot 18 forming a laterally disposed pivot axis 20.

The illustrated mounting bracket 12 includes first and second or left and right lateral portions or components 22, 24. The left and right components 22, 24 are formed as separate components and are secured together to laterally capture the pivot 18 of the pedal arm 14 therebetween such that the left and right components 22, 24 support the pivot 18 and the pedal arm 14 is pivotable about the pivot axis 20 relative to the mounting bracket 12. The illustrated left and right components 22, 24 are molded of a plastic material but alternatively can be formed in any other suitable manner and/or of any other suitable material.

The illustrated left and right components 22, 24 have a vertically disposed and laterally facing connection or separation plane such that the pivot axis 20 is substantially perpendicular to the separation plane. The illustrated left and right components 22, 24 are generally equally sized such that the separation plane is centrally located in the lateral direction but is noted that the components 22, 24 can be sized in any other suitable manner. The left and right components 22, 24 preferably interlock in the forward rearward direction. The illustrated left and right components 22, 24 have a plurality of laterally disposed posts 26 and cooperating openings 28 for receiving the posts 26. The illustrated components 22, 24 have three posts 26 and three openings 28 but any other suitable quantity can alternatively be utilized. The illustrated posts 26 include a forward upper post 26a, a rearward upper post 26b, and a forward lower post 26c. The upper posts 26a, 26b are located on opposite sides of the pivot axis 20. The illustrated posts 26 and openings 28 include cooperating laterally facing steps or abutments 30, 32 so that the posts 26 laterally engage the openings 28 (best shown in FIG. 7). The illustrated posts 26 are heat staked to rigidly secure the left and right components 22, 24 together. The openings 28 extend entirely through the components 22, 24 in the lateral direction in order to provide access to the ends of the posts 28 for heat staking. It is noted that the left and right components 22, 24 can alternatively be secured together in any other suitable manner such as, for example, adhesives, bolts, rivets, or any other suitable manner. The illustrated left and right components 22, 24 also cooperate to form a rear flange 30 where the left component 22 has a pair of protrusions 32 which are received in slots 34 of the right component 24 when the left and right components 22, 24 are laterally brought together. The illustrated rear flange 30 forms a stop for the pedal arm 14 to define a full rearward or un-actuated position. The rear flange 30 can be provided with stopper pad or bumper if desired for engagement by the pedal arm 14. The illustrated rear flange 30 is also provided with a mounting opening 36 for attachment of a switch to indicate when the pedal arm 14 is out of the un-actuated position. This information can be used for example to illuminate brake lights when the pedal arm 14 is depressed by the operator. It is noted that the front flange 30 provides a which bracket that is integral with the mounting bracket, that is, does not have to be separately formed and secured thereto.

The illustrated left and right components 22, 24 also form laterally inward facing sockets 38 for receiving the pivot 18 of the pedal arm 14 (best shown in FIG. 6). The illustrated sockets 38 are blind, that is, they have closed laterally outward ends 40 so that the pivot 18 is captured between the left and right components 22, 24. Note that the sockets 38 form laterally inward facing abutments for the pivot 18. The illustrated sockets 38 are provided with cup-shaped bushings 42 preferably formed of a lower friction material and/or longer wearing material. For example, the bushings 42 can be formed of Nylon or the like.

The mounting bracket 12 is adapted to rigidly attach the adjustable control pedal assembly 10 to a firewall or other rigid structure of the motor vehicle at a fixed position. The illustrated left and right components 22, 24 also cooperate to form a front flange 44 having a plurality of mounting openings 46. The illustrated front flange 44 has four mounting openings 46 but any other suitable quantity can alternatively be utilized. The illustrated the front flange 44 has portions 44a, 44b formed by each of the left and right components 22, 24. The portion 44b formed by the right component 24 overlaps the portion 44a formed by the left component 22 so that the portion 44b formed by the right component 24 forms at least a portion of each of the mounting openings 46. This ensures the mounting openings 46 are located in the desired locations relative to one another. The mounting openings 46 are sized and shaped to receive mechanical fasteners for attaching the control pedal assembly 10 to the structure of the motor vehicle. The illustrated mounting openings 46 are provided with crush limiters 47 (best shown in FIG. 8). The crush limiters 47 are preferably press fit into the left and right components 22, 24 before the left and right components 22, 24 are heat staked or otherwise secured together. The illustrated front flange 44 is also provided with an opening 48 for access to the pedal arm 14 as described in more detail hereinafter. The illustrated right side component 24 is also provided with an access opening 50 as described in more detail hereinafter.

The illustrated pedal arm 14 is generally elongate and formed of a bar having a generally rectangular cross-section. The pedal arm 14 carries the pedal 16 at its lower end. The pedal 16 is sized and shaped for engagement by the foot of the motor vehicle operator so that the operator can depress the pedal arm 14 to actuate a control device. The pedal 16 can be formed unitary with the pedal arm 14 as a one-piece component or can be formed as a separate component and rigidly secured thereto. The pedal can also be provided with a separate pad if desired. The upper end of the pedal arm 14 has the pivot 18 which forms the laterally disposed pivot axis 20. The illustrated pivot 18 is in the form of a hub which in turn is in the form of a hollow tube having a circular cross-section (best shown in FIG. 6). It is noted that the pivot 18 can alternatively have any other suitable form such as, for example, a solid pin. The illustrated pivot 18 extends laterally through an opening 52 near the upper end of the pedal arm 14 and is rigidly secured to the pedal arm 14 so that the opposed ends of the pivot 18 extend laterally outward from the pedal arm 14. The illustrated pivot 18 is rigidly secured to the pedal arm 14 by mechanical deformation of the pivot 18 on each side of the pivot arm by means such as external upsetting of the material of the pivot at beads 54. It is noted that the pivot 18 can alternatively be secured to the pedal arm 14 in any other suitable manner and/or alternatively can be formed unitary with the pedal arm 14 as a one piece component. The pedal arm 14, the pedal 16, and the pivot 18 can each be formed of any suitable material.

The opposite facing free ends of the pivot 18 are received into the sockets 38 of the left and right components 22, 24 as the left and right components 22, 24 are laterally brought together and secured together. With the ends of the pivot 18 in the sockets 38 and the left and right components 22, 24 secured together, the pivot 18 and the pedal arm 14 are captured between the components 22, 24. As best shown in FIG. 6, the pivot 18 is located entirely between the left and right brackets 22, 24 and does not extend to or outward of the lateral sides of the left and right components 22, 24. The mounting bracket 12 supports the pivot 18 and the pedal arm 14 only by engagement at the pivot 18. Clearance space is provided at each lateral side of the pedal arm 14 between the pedal arm 14 and the mounting bracket 12. Supported in this manner, the pedal arm 14 is pivotable relative to the fixed mounting bracket 12 about the horizontally and laterally extending pivot axis 20 formed by the pivot 18 when the vehicle operator depresses the pedal.

A spring member 56 is provided in at least one of the sockets 38 which acts on the pivot 18 to resiliently bias the pivot 18 and the pedal arm 14 in the lateral direction in order to reduce lash in the lateral direction, that is, undesired relative movement in the lateral direction between the pedal arm 14 and the mounting bracket 12. The illustrated spring member 56 is in the form of a wave washer located between the bushing 42 and the blind end 40 of the right side socket 38. It is noted that the spring member 56 can alternatively have any other suitable form such as, for example, a coil spring or a leaf spring and/or can alternatively be located at any other suitable location such as, for example, directly acting on the pivot 18, acting on the pedal arm 14, or at the left side socket 38.

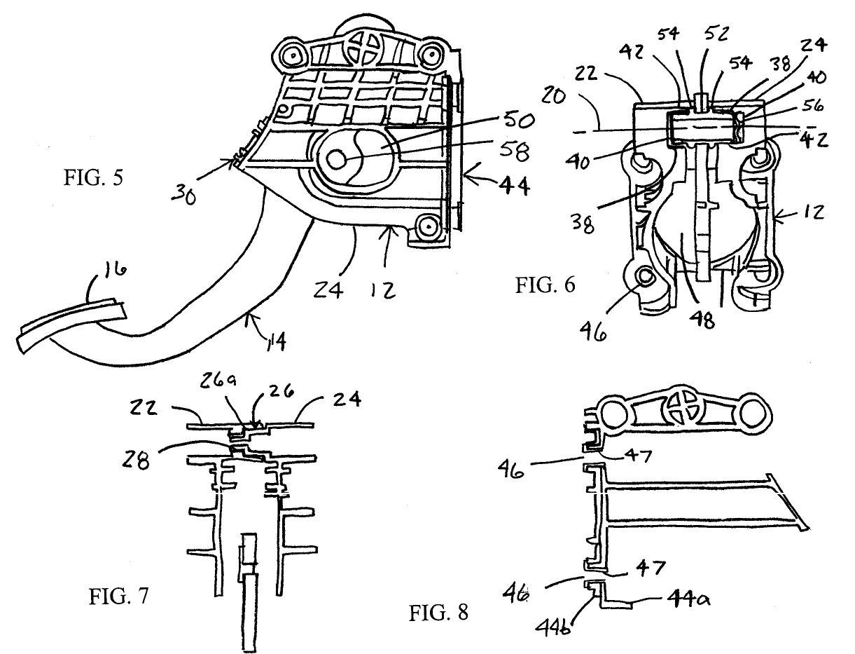

The pedal arm 14 is operatively connected to a control device such as a brake master cylinder so that pivotal movement of the pedal arm 14 about the pivot axis 20 operates the control device in a desired manner. The illustrated pedal arm 14 can be connected to the control device by a mechanical rod or cable for mechanical actuation of the control device. It is noted that the movement of the pedal arm 14 can alternatively be provided to the control device by a sensor and electrical wire, cable, or wireless connection for electronic actuation of the control device. The mechanical rod or cable can be secured to the pedal arm 14 at an opening 58 provided therein and extend through the opening 48 in the front flange 44 of the mounting bracket 12 to the control device. The illustrated opening is provided between the pedal 16 and the pivot 18. The access opening 50 in the right component 24 of the mounting bracket 12 provides access to the pedal arm opening 52 (best shown in FIG. 5) for connection of the rod or cable during installation of the control pedal assembly 10 to the motor vehicle. The control device and/or mechanical rod or cable preferably provides a rearward biasing return spring which resiliently biases the pedal arm 14 to its full rearward or un-actuated position against the stop. Alternatively, a separate return spring can be provided to resiliently bias the pedal arm 14 to its full rearward or u-actuated position against the stop.

To actuate the control device, the operator depresses the pedal 16 with a foot to forwardly pivot both the pedal arm 14 and the pivot 18 together about the pivot axis 20. This forward pivotal movement of the pedal arm 14 pushes the mechanical rod or cable to actuate the control device in the desired manner. When the operator removes the pressure from the pedal 16, the return spring automatically pivots the pedal arm 14 back to its full rearward or un-actuated position against the stop.

From the foregoing disclosure and detailed description of certain preferred embodiments, it is apparent that the illustrated control pedal assembly 10 eliminates the use of a through pivot pin that extends through openings in the mounting bracket and which must be secured in place by means such as spinning, deformation, fasteners, clips or other mechanical means. This eliminates an assembly step and reduces required assembly equipment. It is also apparent that the illustrated control pedal assembly 10 eliminates the need to weld or otherwise attach a switch bracket. This also eliminates an assembly step and reduces required assembly equipment. It is further apparent that the illustrated control pedal assembly 10 utilizes “pick and place assembly” to minimize assembly time and cost.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A pedal assembly comprising, in combination:
a mounting bracket;
a pedal arm having a lower end carrying a pedal and an upper end having a pivot forming a laterally disposed pivot axis; and
wherein the mounting bracket includes first and second lateral components formed as separate components and secured together to laterally capture the pivot therebetween such that the first and second components support the pivot and the pedal arm is pivotable about the pivot axis relative to the mounting bracket.

2. The pedal assembly according to claim 1, wherein said mounting bracket is fixed in position.

3. The pedal assembly according to claim 1, wherein said first and second components are each molded of plastic.

4. The pedal assembly according to claim 3, wherein said first and second components are heat staked together.

5. The pedal assembly according to claim 4, wherein said first and second components have a plurality laterally disposed posts and laterally disposed openings for receiving the posts.

6. The pedal assembly according to claim 1, wherein said first and second components each form a laterally inward facing socket for receiving opposed ends of the pivot therein.

7. The pedal assembly according to claim 6, wherein the laterally outward end of each socket is at least partially closed.

8. The pedal assembly according to claim 6, further comprising a spring member located in one of the sockets to resist lateral movement of the pedal arm relative to the mounting bracket.

9. The pedal assembly according to claim 8, wherein said spring member is a wave washer.

10. The pedal assembly according to claim 6, further comprising bushings located within the sockets.

11. A pedal assembly comprising, in combination:
a fixed position mounting bracket;
a pedal arm having a lower end carrying a pedal and an upper end having a pivot forming a laterally disposed pivot axis;
wherein said mounting bracket includes first and second lateral components which are formed as separate components and secured together to laterally capture the pivot therebetween such that the first and second components support the pivot and the pedal arm is pivotable about the pivot axis relative to the mounting bracket; and
wherein said first and second components each form a laterally inward facing socket for receiving opposed ends of the pivot therein.

12. The pedal assembly according to claim 11, wherein said first and second components are each molded of plastic.

13. The pedal assembly according to claim 12, wherein said first and second components are heat staked together.

14. The pedal assembly according to claim 13, wherein said first and second components have a plurality laterally disposed posts and laterally disposed openings for receiving the posts.

15. The pedal assembly according to claim 11, wherein the laterally outward end of each socket is at least partially closed.

16. The pedal assembly according to claim 11, further comprising a spring member located in one of the sockets to resist lateral movement of the pedal arm relative to the mounting bracket.

17. The pedal assembly according to claim 16, wherein said spring member is a wave washer.

18. The pedal assembly according to claim 11, further comprising bushings located within the sockets.

19. A pedal assembly comprising, in combination:
a fixed position mounting bracket;
a pedal arm having a lower end carrying a pedal and an upper end having a pivot forming a laterally disposed pivot axis;
wherein said mounting bracket includes first and second lateral components which are formed as separate components and secured together to laterally capture the pivot therebetween such that the first and second components support the pivot and the pedal arm is pivotable about the pivot axis relative to the mounting bracket;
wherein said first and second components are each molded of plastic and each form a laterally inward facing socket for receiving opposed ends of the pivot therein;
wherein the laterally outward end of each socket is at least partially closed; and
a spring member located in one the sockets to resist lateral movement of the pedal arm relative to the mounting bracket.

20. The pedal assembly according to claim 19, wherein said first and second components are heat staked together.
